(19) United States
(12) Patent Application Publication
(10) Pub. No.: US 2012/0219937 A1
(43) Pub. Date: Aug. 30, 2012

(54) HAPTIC NEEDLE AS PART OF MEDICAL TRAINING SIMULATOR

(75) Inventors: Chris Hughes, Llanfairpg Gwynedd (GB); Nigel John, Chester (GB)

(73) Assignee: Bangor University, Bangor Gwynedd (GB)

(21) Appl. No.: 13/505,356

(22) PCT Filed: Oct. 29, 2010
(86) PCT No.: PCT/EP10/66489

§ 371 Date: May 1, 2012

(30) Foreign Application Priority Data
Nov. 2, 2009 (GB) 0919164.4
Jan. 28, 2010 (GB) 1001399.3

(51) Int. Cl. G09B 23/32; G09B 23/30

(52) U.S. Cl. 434/268; 434/267

(57) ABSTRACT

The present invention discloses a haptic needle designed to be used as part of a medical training simulator.

### 1. FIELD OF THE INVENTION

The present invention discloses a haptic needle designed to be used as part of a medical training simulator.

### 2. BACKGROUND OF THE INVENTION

Interventional radiology (IR) has been used more and more frequently in the past decade as it provides minimally invasive alternatives to open surgery across several specialties and organ systems. For example, vascular IR uses medical imaging to guide wires and catheters through the vascular tree, accessing and treating a range of pathologies from within the vessels themselves. An essential requirement of this technique is however to obtain vascular access. The process is known as Seldinger technique: it is based on the feel of arterial pulsation to guide the needle into the artery. After introduction of the needle into the vessel, the guide-wire is introduced using tactile sensations, and the needle can then be removed after successful positioning of the guide-wire. This guide-wire is used as conduit for a catheter which is then advanced within the vessel by rotational and translational motions. Medical imaging such as x-ray fluoroscopy is used for guidance in addition to tactile skill and experience of the operator.

It is clear that vessel perforation or other complication is very undesirable, requiring that the operator be highly skilled.

It is also clear that a high level of skill requires serious apprenticeship which is difficult to obtain directly because of the risks and possible discomfort for the patient associated with errors. Besides, the scope of direct apprenticeship is limited to the availability of case mixes and of a mentor.

Virtual simulators have been developed. They offer the advantages of causing no risks for the patient, unlimited practice, and an objective evaluation of performance. The available systems successfully train skills in procedures such as laparoscopic surgery, endotracheal intubation and colonoscopy such as disclosed for example in Seymour et al. (Seymour N. E. Gallagher A. G., Roman et al. in Annals of Surgery 236: 458-463, 2002) or in Sedlack and Kolars (Sedlack R., Kolars J. in Am. J. Gastroenterol. 99:33-37, 2004) or in Rowe and Cohen (Rowe R., Cohen R. in Anesthesia & Analgesia, 95:62-66, 2002).

Vascular IR training simulations are also used. These vascular IR simulations offer a range of case scenarios and pathologies as well as an extensive range of instruments. This method has however not yet been repeated for existing vascular systems. A further limitation of these commercial simulations is a lack of vascular anatomical, pathological and physiological realism such as vessel deformations that are a key property of real world vessel behaviour. In addition, the Seldinger technique as not yet been implemented.

‘In house’ IR simulators have also been developed in order to address more realistic instrument navigation. Finite element methods (FEM) have been used to model the interaction between the surgical instruments and vasculature wherein the instruments were modelled as a system of flexible multiple bodies as disclosed for example by Chui et al. (Chui C. K., Li Z., Anderson J. H., et al. Training and pretreatment planning of interventional neuroradiology procedures—initial clinical validation. Medicine Meets Virtual Reality, vol. 85, 96-102, 2002).

Simulation tools for IR, that include an accurate catheter simulation system interacting with a 3D vasculature and integrating flow simulation have been described by Cotin et al. (Cotin S., Duriez C., Lenoir J., Neumann P., Dawson S. in New approaches to catheter navigation for interventional radiology simulation. Medical image computing and computer-assisted intervention, vol. 8, 534-542, 2005). They model the instruments as non-linear deformable beam elements, while blood flow is simulated via a volumetric approach.

In another approach described by Alderliesten et al. (Alderliesten T., Konings M. K., Niessen W. J. in IEEE Transactions on Biomedical Engineering, Vol. 54, no. 1, 2007), Cosserat models are used to model a guidewire as a set of straight, non-bendable, uncompressible beams with perfect torque control.

In yet another approach described by Basdogan and Srinivasan (Basdogan C., Ho C., Srinivasan M. A. in IEEE/ASME Transactions on Mechatronics, vol. 6, 269-285 2001), the virtual catheter is modelled as mass-spring particles while the deformable anatomical structure uses FEM. The virtual particles are uniformly distributed along the catheter centreline and connected to each other via linear and torsional springs and damping elements. These particles are easier to implement and computationally less expensive than FEM, while providing a physically realistic simulation.

A further approach for virtual catherisation is described in Luboz et al. (Luboz V., Blazewski R., Gould D. and Bello F., in Real-time Guidewire Simulation in Complex Vascular Models. The Visual Computer. Springer Berlin/Heidelberg. ISSN 0178-2789, 1432-2315, 2009). It provides a realistic model for the guidewire, complex vascular models, real time simulation, and the use of an IR specific haptic device. It offers realistic catheter/guidewire interaction as well as a vessel puncture haptic device.

### SUMMARY OF THE INVENTION

It is an objective of the present invention to provide a training device for the introduction and orientation of a needle in a vessel in the Seldinger technique.

It is another objective of the present invention to provide a training device for the introduction and orientation of a needle into an organ for biopsy or treatment.

It is also an objective of the present invention to provide a method for guiding the needle into a vessel or organ.

It is a further objective of the present invention to guide the introduction of the subsequent guide-wire and catheter into the vessel.

It is a yet further objective of the present invention to train future interventional radiologists for vascular interventions by helping in the acquisition of navigation skills, preferably in the Seldinger technique.

In accordance with the present invention, the foregoing objectives are realised as described in the independent claims. Preferred embodiments are described in the dependent claims.

### BRIEF DESCRIPTION OF THE DRAWINGS

FIG. 1 represents a haptic needle including an array of light emitting diodes for use in a training simulator.

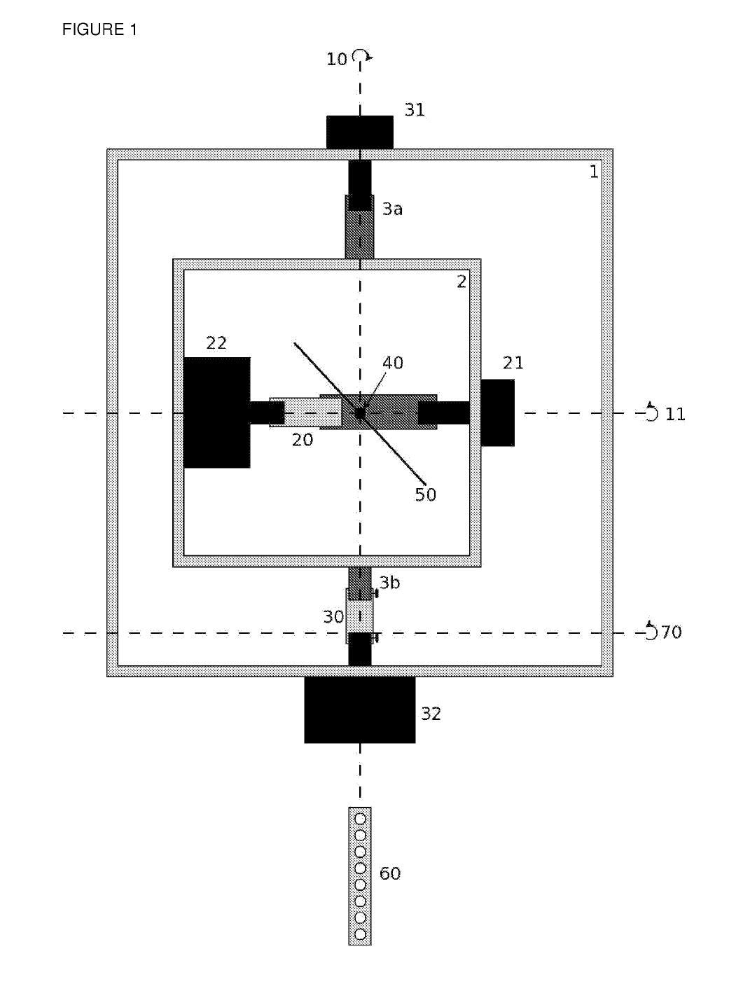

FIG. 2 represents the same haptic needle as that of FIG. 1 further including a synthetic skin.

FIG. 3 represents a side view of the haptic needle device of FIG. 1.

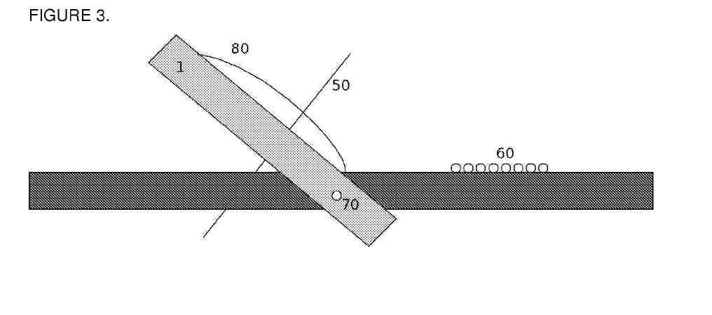

FIG. 4 shows three examples of vasculatures: one non pathologic, one with two aortic aneurisms, and one with an aortic dissection.

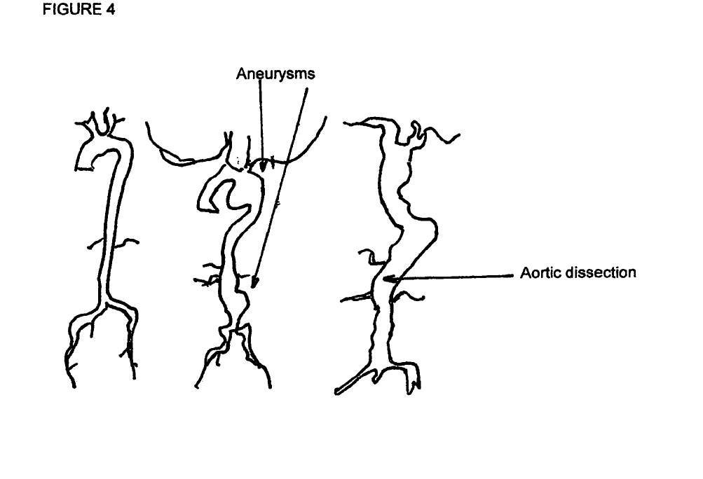

### DETAILED DESCRIPTION OF THE INVENTION

After insertion of the needle into a vessel or into an organ, it is essential to have the ability to manipulate the needle in terms of orientation, rotation and depth. The clinician must adapt the orientation of the needle tip to ensure that it is correctly positioned within the vessel, thereby allowing alignment of the entry point for the guidewire along the vessel or into an organ for biopsy or treatment.

Accordingly, the present invention discloses a haptic needle, for use in a medical training simulator comprising:
a) a fixed rigid outer frame (1) of circular or elliptical or polygonal shape;
b) a mobile rigid inner frame (2) of circular or elliptical or polygonal shape, located inside the outer frame and connected to said outer frame by two rigid arms (3a) and (3b), each located between the inner wall of the outer frame and the outer wall of the inner frame and perpendicular to said walls, aligned in the prolongation of each other and positioned on opposite sides of the inner frame to intersect said inner frame in two substantially equal segments, thereby defining a first axis (10) allowing rotation of the inner frame with respect to the outer frame, said axis being interrupted inside the inner frame;
c) a first potentiometer (21) fastened to the inner frame and located at one end of a second axis (11) perpendicular to the first axis (10) defined in b), said second axis intersecting the inner frame in two substantially equal segments;
d) a first micro servo (22) connected to the inner frame and located at the other end of second axis (11);
e) a first adjustable linkage (20) located inside the inner frame, on second axis (11) and adjacent to first micro servo (22);
f) a second potentiometer (31) fastened to the outer frame and located at one end of first axis (10);
g) a second micro servo (32) connected to the outer frame and located at the other end of first axis (10);
h) a second adjustable linkage (30) located on first axis (10), adjacent to second micro servo (32);
i) a circular cavity (40) for inserting a needle, located within the inner frame, at the virtual intersection between first axis (10) and second axis (11);
j) a needle (50) inserted in cavity (40);
k) a pressure sensor (80), able to rotate with respect to the frame about an axis (70) parallel to axis (11) and linked to the frame at adjustable linkage (30);
l) an array of light emitting diodes (LED) (60) aligned with axis 10;
m) artificial skin (81).

The rigid outer and inner frames can be prepared independently from any known rigid material such as metal or plastic, as long as it does not deform or collapse or interfere with the motion of the haptic needle. In a preferred embodiment according to the present invention, it is prepared from aluminium.

The outer and inner frames are preferably polygons and more preferably rectangles having their respective sides parallel to one another. This allows the two axes defined by the adjustable linkages to join respectively two opposite sides of the rectangular frames, making the geometry of the system simple and thus easy to adjust. The orientation of the needle in the vessel requires small and precise motions. It is thus important to reach high accuracy in the simulation process.

The size and thickness of the frames are not particularly limited but it is convenient to work with an outer frame having sides ranging between 8 and 20 cm and an inner frame having sides ranging between 3 and 8 cm, both having a width of the order of from 1 to 3 cm. It is possible to downsize the device if needed.

The needle is inserted into the cavity that is positioned at the intersection of the two adjustable linkages. These two linkages form two perpendicular axes, X and Y, whereas the third axis Z is provided by the shaft of the cavity. The rotation and depth of the needle are thus fully defined in three dimensions with respect to these 3 axes. The prototype allows rotation to an angle of up to + or −45 degrees from the centre point on both X and Y axes. The rotation accuracy is excellent, of the order of 0.1%.

The potentiometer is not particularly limited. It is any commercially available high precision potentiometer with a typical voltage of about 5 volts, of the same order as USB links. It is linked to an analogue to digital converter (ADC) in order to transmit the orientation data to the simulation software.

The servos are not limited and can be selected from any commercially available servo. Preferably they have a steel gear box, having a higher precision and resistance than nylon gear boxes. They are also connected to an ADC insuring the connection to the simulation software. It must be noted that the servo being a mechanical device has a lower accuracy than the potentiometer which is an electronic device

The adjustable linkages allow a level of resistance to be applied to the orientation of the needle in a scenario designed to avoid damage to the vessel and to represent the actual soft tissue and muscle resistance applied to the needle during its progression within the vessel or organ. The resistance is typically implemented by the servo that is programmed to drive against or with the motion of the needle in response to information received from the simulation software. The orientation of the needle recorded by the potentiometer is transmitted to a vascular simulation platform. The simulator then displays the state of the virtual instruments within the vasculature in real time.

Optionally a pressure sensor is added to the haptic needle system. Its role is to record the position and pressure exerted by the surgeon's fingers in the vicinity of the inserted needle in order to stop bleeding. It is typically a rotary potentiometer, linked to a feedback software, in order to inform the trainee whether the pressure was efficiently applied. In a preferred embodiment according to the present invention, the pressure sensor is a hollowed disc-shaped rotary potentiometer, covering the open surface of the inner frame with the opening in the disc positioned to allow access to the needle.

A Linear Array of 8 tri-Coloured Light Emitting Diodes (LED) is added to the top of the Haptic Needle frame, in a single line. It simulates the blood flow and aligns the inner frame in the direction indicated by the needle hub position, before advancing a guidewire. The LED's are driven by the software simulation and symbolise the flow of blood from the hub of the needle. It is a visual cue, which is essential for the clinician to identify that the tip of the needle is inside the flow of blood within the virtual vessel. The flow of blood must be present, and blood must continue to flow either until an instrument, such as a guidewire, is inserted, or until the clinician's fingers depress the vessel in order to stem the flow. The pressure sensor is used to detect said fingers pressure.

In addition, the tri-colour LED's are used to allow the blood to change colour in order to represent accurately the difference between arterial and venous blood colours. This enables the clinician to determine whether he is in a vein or in an artery. Similarly the simulation allows the intensity and cycle speed of the LED's to accurately represent the bloodflow at the tip of the needle. For example, a needle positioned in the centre of flow of a healthy artery will ‘spurt’ at a much higher intensity and velocity than a needle embedded in the wall of a diseased artery.

An artificial, silicone based, skin is used to cover the haptic needle and provide a realistic touch and feel for the interface. The artificial skin comprises a flesh-coloured layer of silicon. Optionally, it has a skin nick in the area where the clinician performs the needle puncture. It may also optionally be equipped with a funnel shaped appendage, attached to the back of the skin, to ensure that the needle and tools enter into the haptic needle device. Alternatively, it is possible to provide a skin without the nick, for better realism allowing the clinician to perform the entire puncture. Such skin system is however not reusable. The artificial skin may also include a slightly raised surface associated with the position of the pressure sensor, ensuring that finger positioning is carried through the skin to the pressure sensor.

The entire simulator may also be draped in a genuine surgical drape, in order to hide the mechanics, and to improve the face validity of the environment.

The core of the simulator computes adequate response forces which are communicated to the VSP and then applied to the instruments as frictions or resistances. When collisions are detected between the instruments and the vascular or organ network, resistance is applied to the needle and vice versa, when the orientation is correct, a reduced resistance is applied to the needle favouring its motion.

The detection of collisions has been described for example in Luboz et al. (Luboz V., Blazewski R., Gould D. and Bello F. (2009). Real-time Guidewire Simulation in Complex Vascular Models. The Visual Computer. Springer Berlin/Heidelberg. ISSN 0178-2789, 2009. It uses an Axis Aligned Bounding Boxes (AABB) tree to partition the vasculature as described in Wang et al. (Wang F., Duratti L., Samur E., Spaelter U. and Bleuler H. A. in Proceedings of the 29th Annual International Conference of the IEEE EMBS, Lyon, France, August 2007).

At each simulation loop, the colliding particles are displaced to ensure that they remain within the vasculature. As the needle is a rigid object, only an external friction needs to be applied to move the particle away from collision.

The collision information is fed into the servo which receives information from the simulation software concerning the cause of collision and the level of friction encountered. This information is transmitted to the adjustable linkages under the form of a level of resistance applied to the rotation around said linkages by driving the servo against the intended rotation with the a speed appropriate to the level of friction. A simulated pulse is also applied to the needle by the servo.

In another embodiment according to the present invention, the level of resistance is applied to the needle by an electronic brake.

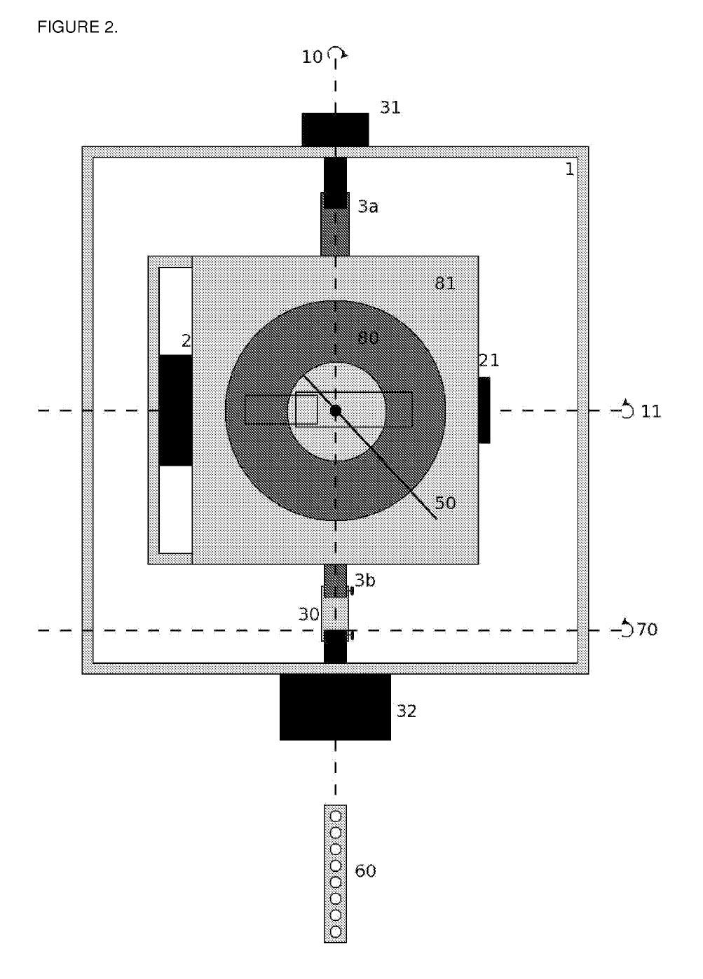

For efficient training, it is essential to have access to a wide variety of cases and pathologies, each with a large amount of vascular details. 23 real vasculatures have been integrated in the simulator, 14 males, and 9 females. The vasculature covers the same arteries: aorta, renal arteries, iliac and femoral arteries, and beginning of the neck vessels. FIG. 2 shows three examples of vasculatures: one non pathologic, one with two aortic aneurisms, and one with an aortic dissection. The datasets have been generated by clinicians using manual segmentation or semi automatic segmentations, as explained in Luboz et al. (Luboz V., Din N., Song Y., King D., Gould D., Bulpitt A. and Bello F. in Proceedings of the Workshop of British Machine Vision Association (BMVA), London, UK, 2008).

A wide variety of patients gives trainees the opportunity to try different approaches and different instruments in several virtual cases integrated in the simulator.

The present simulator includes vessel deformation during instrument navigation and vessel elasticity.

This simulation device is part of a complete training system comprising the insertion of the needle, its orientation in the vessel, the insertion and motion of a guidewire and the insertion and motion of a catheter.

The needle insertion haptic device has been described in Luboz et al. (V. Luboz, C. J. Hughes, D. A. Gould, N. W. John, F. Bello, in International Journal of Computer Assisted Radiology and Surgery., Vol. 4, No. 6, p 589-596, 2009). It is based around a fixed pivot point, allowing the needle to be inserted or to be removed in order to allow insertion of the guidewire and catheter through its center. A flexible tube is attached to the back-end of the pivot point, thus directing both the guidewire and catheter into the catheterisation haptic device.

Once the needle is inserted properly in the vessel, it needs to be oriented correctly. This is achieved with the haptic device according to the present invention. Next, the trainee introduces a guidewire and exchanges the needle for a catheter, or for an access sheath through which a wire/catheter can be navigated inside the vessel towards the pathology. This step can also be simulated. Guidewire and catheter are tracked using a commercial catheterisation haptic device known as VSP (Vascular Simulation Platform, Mentice). It allows tracking two real instruments coaxially at the same time while an operator manipulates them as done in a real intervention, under virtual fluoroscopy or in a road map. Each motion is transferred to the core of the simulator which then displays the state of the virtual instruments within the vasculature in real time.

The simulator is connected to the needle insertion haptic device and to the catherisation haptic device. The instruments' position provided by the devices is used by the simulator core to update the position of the virtual instruments in real time. Physics-based models are used to simulate the behaviour of the instruments. The needle is a rigid object, while the catheter and guidewire are represented by mass-spring models

In such a system, the interaction between the instruments must be determined realistically and therefore a hierarchy must be established. The needle's particles being rigid override all other instruments. When an instrument is in the needle, it follows its path rigidly. Outside the needle, the catheter's particles are influencing the guidewire particles and vice versa. The guidewire follows each motion of the catheter, unless it has part of its particles outside the catheter. In that case, the portion of the guidewire particles inside the catheter follow its motion, whereas the portion of the guidewire particles outside the catheter satisfies the collision response forces, especially the spring and bending forces. When the guidewire is moving, it may also influence the catheter's position depending on the catheter's flexibility. This complex set of interactions allows bifurcating in different vessels, thereby provides realistic navigation of the instruments inside the vasculature.

The present invention also provides a method for training the orientation of the needle into a vessel in the Seldinger technique with the device of claim 1 that comprises the steps of:
a) inserting a needle into the circular cavity of the device;
b) recording the needle's orientation in X and Y by the two potentiometers, said two potentiometers also acting as pivot points;
c) providing a servo connected to a software simulating a real life vascular or organ system and showing the position of the inserted needle with respect to the target vessel or organ;
d) feeding information received by the servo to drive the frame to starting position;
e) rotating the needle about the two axes X and Y defined by the adjustable linkages directions in order to modify the orientation of said needle within the target vessel or organ;
f) recording the new orientation parameters by the potentiometers;
g) transmitting the orientation parameters to the servo;
h) transmitting to the needle resistance parameters received by the servo from the software in order to represent real conditions of needle within the vessel or organ, said transmission being carried out by the adjustable linkage;
i) simulating the bloodflow at the at the current needle position using LED's to inform the clinician about his progress;
j) repeating steps e) through i) until proper needle orientation is achieved.

The needle, when inserted into the cavity, is allowed to move along the axis of the cavity which is perpendicular to the plane defined by the X and Y axes defined previously, i.e. the first axis carrying the potentiometer and servo of the inner frame and the second axis carrying the potentiometer and servo of the outer frame. This new axis defines the third axis of a three-dimensional system.

### EXAMPLE

Visual C++ was used to program the core of the environment. The user interface was handled by FLTK (Fast Light Tool Kit, http://www.fltk.org/) while the graphics used the VTK library (Visual Tool Kit, http://www.vtk.org). The haptic device was linked to the program via a proprietary library.

The external frame was a 12 cm×14 cm rectangle having a width of 2 cm and prepared from aluminium.

The internal frame was a 6 cm×6 cm square having a width of 2 cm and prepared from aluminium.

The potentiometer was model 10K 357 with rotation stop from Rapid Electronic Components and the servo was model HS82MG-RC from Hitech

The pressure sensor was a hotpot rotary potentiometer model SEN-09074 from Sparkfun Electronics.

1. A haptic needle, for use in a medical training simulator comprising:
a) a fixed rigid outer frame of circular or elliptical or polygonal shape;
b) a mobile rigid inner frame of circular or elliptical or polygonal shape, located inside the outer frame and connected to said outer frame by two rigid arms, each rigid arm located between an inner wall of the outer frame and an outer wall of the inner frame and perpendicular to said walls, aligned in the prolongation of each other and positioned on opposite sides of the inner frame to intersect said inner frame in two substantially equal segments, thereby defining a first axis allowing rotation of the inner frame with respect to the outer frame, said axis being interrupted inside the inner frame;
c) a first potentiometer fastened to the inner frame and located at one end of a second axis perpendicular to the first axis, said second axis intersecting the inner frame in two substantially equal segments;
d) a first micro servo connected to the inner frame and located at the other end of second axis;
e) a first adjustable linkage located inside the inner frame, on second axis and adjacent to the first micro servo;
f) a second potentiometer fastened to the outer frame and located at one end of the first axis;
g) a second micro servo connected to the outer frame and located at the other end of the first axis;
h) a second adjustable linkage located on the first axis, adjacent to the second micro servo;
i) a circular cavity for inserting a needle, located within the inner frame, at a virtual intersection between the first axis and the second axis;
j) a needle inserted in the cavity;
k) a pressure sensor that is configured to rotate with respect to the outer frame about a third axis parallel to the second axis and linked to the outer frame at the second adjustable linkage;
l) an array of light emitting diodes (LED) aligned with the first axis; and
m) artificial skin.

2. The haptic needle of claim 1 wherein both outer and inner frames are regular polygons.

3. The haptic needle of claim 2 wherein the regular polygons are rectangles having sides parallel to one another.

4. The haptic needle of claim 1 wherein one of the potentiometers is a high precision potentiometer having an accuracy of 0.1%.

5. The haptic needle of claim 1 wherein one of the servos has a steel gear box.

6. The haptic needle of claim 1 additionally comprising a pressure sensor to record position and pressure exerted by trainee's fingers in the vicinity of the inserted needle.

7. The haptic needle of claim 1 additionally comprising an array tri-coloured LED's to simulate the blood flow.

8. A method for training the orientation of the needle into a vessel or into an organ with the haptic needle of claim 1 that comprises the steps of:
a) inserting a needle into the circular cavity;
b) recording the needle's orientation in X and Y by the two potentiometers, said two potentiometers also acting as pivot points;
c) providing a servo connected to a software simulating a real life vascular or organ system and showing the position of the inserted needle with respect to a target vessel or organ;
d) feeding information received by the servo to drive the frame to starting position;
e) rotating the needle about the two axes X and Y-defined by the adjustable linkages directions in order to modify the orientation of said needle within the target vessel or organ;
f) recording the new orientation parameters by the potentiometers;
g) transmitting the orientation parameters to the servo;
h) transmitting to the needle resistance parameters received by the servo from the software in order to represent real conditions of needle within the vessel or organ, said transmission being carried out by one of the adjustable linkages;
i) simulating the bloodflow at the current needle position using tri-coloured LED's to inform the clinician about his progress;
j) repeating steps e) through i) until proper needle orientation is achieved.

9. The method of claim 8 wherein the needle is configured to rotate about the X and Y axes by an angle of up to + or −45°.

10. Use of the haptic needle of claim 1 in a Seldinger technique.
